(19) United States
(12) Patent Application Publication
(10) Pub. No.: US 2016/0316754 A1
(43) Pub. Date: Nov. 3, 2016

(54) WOOD PRESERVATIVE

(71) Applicant: Arch Wood Protection Pty Ltd, Tullamarine (AU)

(72) Inventors: David Humphrey, Tullamarine (AU); Brett Skewes, Tullamarine (AU)

(21) Appl. No.: 15/209,950

(22) Filed: Jul. 14, 2016

Related U.S. Application Data
(62) Division of application No. 14/368,089, filed on Jun. 23, 2014.

(30) Foreign Application Priority Data
Dec. 23, 2011 (AU) 2011905439

(51) Int. Cl. A01N 43/653; A01N 37/10; B27K 3/02; B27K 3/22; B27K 3/34; A01N 53/00; B27K 3/08

(52) U.S. Cl. CPC A01N 43/653; A01N 53/00; A01N 37/10; B27K 3/08; B27K 3/22; B27K 3/343; B27K 3/0228; B27K 2240/20

(57) ABSTRACT

According to the present invention there is provided a preservative formulation for use in treating wood or other cellulosic formulations, said formulation comprising: at least one biocidal metal compound; at least one organic compound; and a carrier. Preferably, the preservative formulation is copper/(tebuconazole/propiconazole) in a ratio of about 1:3 w/w; the carrier is preferably aqueous or spirit-based.

### CROSS-REFERENCE TO RELATED APPLICATION

This application is a Division of U.S. application Ser. No. 14/368,089 filed Jun. 23, 2014 of which is a 371 of Application No. PCT/AU2012/001556, filed Dec. 19, 2012, which claims the benefit of Australian Application No. 2011905439, filed Dec. 23, 2011, the contents of each of which are incorporated herein by reference.

### FIELD OF THE INVENTION

The present invention relates to the treatment of wood products and other cellulosic substrates with a preservative formulation. More specifically, the invention relates to the treatment of wood with a preservative mixture, which comprises “inverse” proportions of metal and organic compound, relative to those presently used in the art. That is, the inventive formulation comprises a generic “high organic compound/low metal compound” ratio of biocidal agents.

The invention has been developed primarily for use in treating timber which is used in residential applications. For example, treatment of decking timbers with the inventive formulation renders the treated wood resistant to insect and fungal decay over a predetermined period. Although the invention will be described hereinafter with reference to this application, it will be appreciated that it is not limited to this particular field of use.

### BACKGROUND OF THE INVENTION

Any discussion of the prior art throughout the specification should in no way be considered as an admission that such prior art is widely known or forms part of the common general knowledge in the field.

Wood is a staple construction formulation used throughout the world. However, it is prone to degradation from elements including the natural environment, weather events, insects, rot and fire. Accordingly, a range of chemical treatments has been developed to improve the durability and working lifetime of wooden structures.

To treat and prevent infestations, timber is often impregnated with a preservative or preservative mixture comprising fungicide/s and/or or insecticide/s. The preservative is typically present in a carrier, with the mixture being applied to the surface of the timber, for example by dipping, spraying, brushing or pressure treatment, such that the carrier and preservative are absorbed in to the timber.

The treatment of timber or timber products with preservative compounds involves the introduction of stable chemicals into the cellular structure of the timber. This, in turn, protects the timber from hazards such as fungi, insects and other wood-destroying organisms. Preservative treatments may also include the introduction of chemicals that improve resistance to degradation by fire.

Preservative treatment of wood is sometimes carried out at increased pressure so as to force the liquid preservative solution into the pores of the wood. A vacuum may be applied prior to the introduction of the treatment solution in order to increase penetration. Irrespective of whether they are subject to pressure-based application methods, preservative solutions are generally of relatively low viscosity in order to facilitate the penetration of the treatment solution.

Increased penetration of the preservative solution can also be achieved by diffusion, which despite involving less expensive equipment, requires a longer time period and greater levels of stock holding. Diffusion time is also influenced by the initial wood moisture content, especially when dealing with aqueous carriers.

TABLE 1
Minimum preservative retention in the
penetration zone: Hazard Class 3 (H3)
Light organic solvent preservatives/waterborne

| Preservative | Minimum Retention (TAE, % m/m) |
|---|---|
| CCA | 0.38 |
| Cu + DDAC | Softwood 0.35; Hardwood 0.39 |
| Copper azole | 0.229 |
| Creosote | 8 |
| TBTN or TBTO | 0.08 (tin, vertically exposed); 0.16 (tin, |
| | horizontally exposed) |
| Propiconazole & Tebuconazole | Softwood 0.06 (total azole) |
| Copper naphthenate | 0.1 (copper) |
| Synthetic pyrethroids | Permethrin 0.02; Cypermethrin 0.03; |
| | Deltamethrin 0.002; Bifenthrin 0.0047 |

In Australia, the treatment of timber is governed by the Australian standard “AS 1604-2010”. Hazard Class H3 is defined as being for protection against “moderate fungal decay and termite hazard for decking, fascia, cladding, window reveals, and exterior structure timber”. Decking is one such example. The timber is exposed to the weather or not fully protected. It is clear from the ground and the area is well drained and ventilated. H3 treatment is designed to prevent attack by insects, including termites, and decay.

Hazard Class H4 defines “severe decay, borers and termites, fence posts, greenhouses, pergolas (in ground and landscaping timbers)”. The timber is in contact with the ground or is continually damp so there is a severe decay hazard. The treatment stops attack by insects, including termites, and severe decay.

“Penetration” is defined under the H3/H4 Standards as: “All preservative-treated wood shall show evidence of distribution of the preservative in the penetration zone in accordance with the following requirements: (a) If the species of timber used is of natural durability class 1 or 2, the preservative shall penetrate all the sapwood. Preservative penetration of the heartwood is not required; (b) If the species of timber used is of natural durability class 3 or 4, the preservative shall penetrate all of the sapwood and, in addition one of the following requirements shall apply; (bi) Where the lesser cross-sectional dimension is greater than 35 mm, the penetration shall be not less than 8 mm from any surface. Where the lesser cross-sectional dimension is equal or less than 35 mm, the penetration shall be not less than 5 mm from any surface; and (bii) Unpenetrated heartwood shall be permitted, provided that it comprises less than 20% of the cross-section of the piece and does not extend more than halfway through the piece from one surface to the opposite surface and does not exceed half the dimension of the side in the cross-section on which it occurs”.

As mentioned above, a carrier must be used in order to facilitate penetration of the preservative into the timber. As shown in the Australian Standards, the carriers presently available can be characterised broadly as “water-borne” or “solvent-borne” systems.

A carrier must be capable of providing sufficient penetration of the preservative into the wood, thereby to provide an effective barrier against infestation. Other considerations in the choice of carrier include the desired rate of penetration, cost, environmental, health and safety considerations. A carrier may provide for a “complete penetration” formulation, or for an “envelope penetration” formulation in which a defined migration of one or more preservatives into the wood is achieved.

The preservatives commonly used in timber treatment can be characterised according to the carrier vehicle used to carry preservatives into the timber, and by the active chemicals protecting against the various hazards. The final step in the preservation process is often that a solvent, if used in or as the carrier, must then be removed before the timber is made available for use.

Light Organic Solvent-borne Preservatives (LOSPs) comprise a light organic solvent, typically white spirits, to carry the preservative into the timber. The solvent is drawn out in the final stages of treatment, with the preservative remaining within the wood. Such preservatives are typically fungicides, having copper, tin, zinc, azoles and pentachlorophenols (PCPs) as major toxicants. Synthetic pyrethroids such as permethrin may be incorporated within the preservative composition if an insect hazard is also present. One principal advantage of LOSP treatment is that the treated timber does not swell, making such treatment quite suitable for “finished” items such as mouldings and joinery. The majority of LOSPs used in wood treatment also contain insecticides and/or waxes so as to give the surface water repellent properties. However, odour and exposure to VOCs (volatile organic compounds) are significant environmental/occupational health and safety issues. Accordingly, whilst effective, LOSP treatments are becoming increasingly undesirable. However, the LOSP procedure does have an advantage in that it does not add moisture back into the timber. Excessive moisture uptake can affect the dimensions of timber.

Water-based systems typically require a significant uptake of any water-based treatment composition in order to provide the required penetration through to the core of the timber. This results in an increase of the moisture content of the timber, which in turn affects the dimensional stability of the timber and may also require that the timber be redried prior to use.

The use of biocidal metal ions in wood preservation is well known. There are also many compounds containing an azole group which are known to possess biocidal properties. Indeed, it is known from WO 93/02557 that a metal compound and a fungicidal compound containing a triazole group may exhibit synergistic fungicidal activity. This document describes preservative compositions comprising a biocidal metal compound, most preferably in the form of copper; and a fungicidal triazole compound. The optimum weight ratio of metal ion to triazole compound varies depending on the particular material or product to which the composition is applied and the type of organism against which protection is required. However, preferably the ratio by weight of metal to triazole compound is less than 1000:1, e.g., no greater than 750:1. More preferably, the weight ratio of metal: triazole compound should be between 750:1 and 1:1, particularly preferably between 500:1 and 2:1; most preferably the ratio is between 50:1 and 5:1, especially about 25:1. Most preferably, the metal is copper and the triazole is tebuconazole, or a mixture of triazoles tebuconazole and propiconazole.

The concentration required for preservative treatment depends on the ratio of metal to triazole compound selected, the metal chosen, the method of treatment employed, the timber species, the level of protection required and the nature and quantity of any other biocides present. In general, the level of metal required will be in the range 0.01-5% and the level of triazole will be in the range 25 ppm to 1.0%. The preferred range for waterborne treatments is to have a metal concentration of 0.1-5% and a triazole level of 50 ppm to 5000 ppm.

It will thereby be appreciated that WO 93/02557 describes generic “high metal/low organic compound” biocidal formulations. These formulations can be used in waterborne pressure treatment processes. Commercially, it is a preservative mixture that contains copper, boric acid and tebuconazole. Such a formulation was introduced in Australia as a replacement for copper-chrome-arsenate (“CCA”) for treatments having external applications.

WO 95/14558 teaches that although “high metal/low azole” formulations are exemplified and indeed “preferred”, the generic “low metal/high azole” proportions are nonetheless optional—at least within a w/w ratio of about 1:2.5.

It will be understood that the metal compound may be present in a form such that metal ions are free in solution, may form part of a complex, or may be micronised. Similarly, the triazole compound may be free in solution or may be present in the form of a salt or a complex. For example, the triazole compound could be present in the form of a complex with part of the biocidal metal ion.

The metal compound may be a compound of any biocidally-active metal including copper, aluminium, manganese, iron, cobalt, nickel, zinc, gold, silver, cadmium, tin, antimony, mercury, lead and bismuth; these may be either used alone or in mixtures. The preferred metals are copper and zinc used alone, in combination with each other or with one or more of the metals listed above. The most preferred metal is copper, particularly as the Cu(II) ion. The metal may be solubilised in the aqueous carrier or micronised.

In cases where zinc is used instead of copper, it is know that typically three times as much zinc (cf. copper) is required for control of decay organisms. Accordingly, the optimum ratio in the case of zinc may be 1:1 total zinc:azole.

Inorganic boron compounds have been used to protect the sapwood of susceptible hardwoods against lyctid or “powder post” borers. Such treatment consists of soaking freshly-sawn unseasoned timber in solutions of boron salts. The salts diffuse through the timber, thereby treating it, and after such treatment, the timber is allowed to dry. However, boron salts are readily soluble in aqueous solutions and can be leached relatively easily from the wood once treated. This largely restricts boron-treated timber to interior uses such as flooring or joinery, wherein it is protected from the external environment.

It is an object of the present invention to overcome or ameliorate at least one of the disadvantages of the prior art, or to provide a useful alternative. The present invention thereby seeks to provide a wood treatment formulation that meets the industry-specific standards of active ingredient retention and penetration. The treated wood should preferably have good dimensional stability. The advantages in obtaining an industrially-effective “low metal/high preservative” formulation may be both economic and environmental.

The present invention result in effective penetration for a variety of different biocidally-effective active agents having an antifungal or other biocidal role having surprisingly shorter exposure times to yield a moisture content of the treated timber of less than 25% and preferably less than 20% w/w. The present invention recognises many different actives can be carried into the wood without the need for resins and/or curing agents in the aqueous carrier. The present invention recognises the option of including a wetting agent and/or surfactant. Preferred actives include fungicides, mouldicides, insecticides and termiticides.

Despite the many and varied techniques for the treatment of wood, there remains a need to satisfy the “dry after” requirement for treated timber, having less than 15% moisture content, whilst achieving the required penetration of active compounds into the wood.

Unless the context clearly requires otherwise, throughout the description and the claims, the words “comprise”, “comprising”, and the like are to be construed in an inclusive sense as opposed to an exclusive or exhaustive sense; that is to say, in the sense of “including, but not limited to”.

Although the invention will be described with reference to specific examples it will be appreciated by those skilled in the art that the invention may be embodied in many other forms.

### SUMMARY OF THE INVENTION

According to a first aspect of the present invention there is provided a preservative formulation for use in treating wood or other cellulosic materials, said formulation comprising:
at least one organic compound;
at least one metal compound; and
a carrier,

wherein the ratio of said at least one metal to said at least one organic compound is between about 5:1 and about 1:10 w/w.

In preferred embodiments, the ratio of said at least one metal to said at least one preservative is between about 1:1 and about 1:10 w/w.

In other preferred embodiments, the ratio of said at least one metal to said at least one preservative is between about 1:2.5 and about 1:10 w/w. Alternatively, the ratio of said at least one metal to said at least one preservative is between about 3:1 and about 1:10 w/w Alternatively, the ratio of said at least one metal to said at least one preservative is between about 1:3 and about 1:10 w/w. The present invention canvasses metal:azole ratios from around 1:1 to about 1:100 w/w. Most preferably, the ratio of said at least one metal to said at least one preservative is about 1:3.1 w/w.

In a preferred embodiment, the metal compound may be biocidal. In another preferred embodiment, the preservative formulation achieves substantially full sapwood penetration in compliance with the Australian Standard AS 1604.

The carrier can be any carrier applicable to wood preservative technologies, such as LOSP (e.g., white spirit, kerosene), water (with organic compounds optionally included as emulsions), oil and mixtures thereof.

In a preferred embodiment, the metal compound is a compound of a metal selected from the group consisting of: copper, aluminium, manganese, iron, cobalt, nickel, zinc, silver, cadmium, tin, antimony, mercury, lead and bismuth. Preferably, the metal compound is a compound of copper or zinc. More preferably, the copper compound is a copper(II) compound.

In a preferred embodiment, the copper or zinc compound is selected from the group consisting of: copper or zinc naphthenate, copper or zinc octanoate (2-ethylhexanoate), copper or zinc abietate, copper or zinc tallate and copper or zinc oxine or a copper or zinc soap.

In a preferred embodiment, the organic compound is a fungicide; the Applicant has observed a synergy between metals and fungicides. Alternatively, the one or more organic compounds are selected from the group consisting of: insecticides, termiticides, fungicides, mouldicides, or the like, and mixtures thereof. Preferably the preservative is selected from the group consisting of: synthetic pyrethroids (such as allethrin, bifenthrin, cypermethrin, cyphenothrin, deltamethrin, permethrin, prallethrin, resmethrin, sumithrin, tetramethrin, tralomethrin, transfluthrin, imiprothrin), azoles, triazoles, copper azole-based compounds, organic biocides, thiachloprid, imidachloprid or the like, and mixtures thereof, triazoles, copper azole-based compounds, organic biocides, iodopropynylbuthylcarbamate (IPBC), organic tin compounds such as tributyltin naphthenate (TBTN), organic copper compounds such as copper 8 quinolinolate, copper naphthenate, organic zinc compounds, quaternary ammonium compounds, tertiary ammonium compounds, isothiazolones, boron compounds, 3-benzothien-2-yl-5,6-dihydro-1,4,2-oxathiazine-4-oxide (Bethogard®) and bis-(N-cyclohexyldiazenuimdioxy) copper (“Cu-HDO”)”, and mixtures thereof

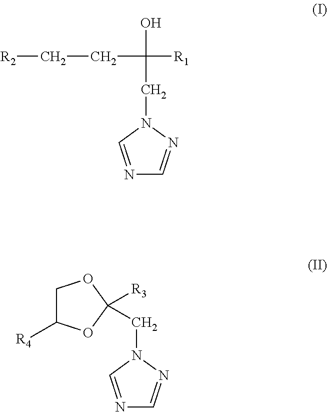

In a preferred embodiment, the preservative is a triazole compound of formulae (I) or (II), above, wherein R₁ represents a branched or straight chain C1-5alkyl group; R₂ represents a phenyl group optionally substituted by one or more substituents selected from halogen, C₁₋₃alkyl, C₁₋₃alkoxy, phenyl and nitro; R₃ is as defined for R₂; and R₄ represents a hydrogen atom or a branched or straight chain C₁₋₅alkyl. Preferably, the triazole compound of formula (I) is tebuconazole (α-[2-(4-chlorophenyl)ethyl]-α-(1,1-dimethylethyl)-1H-1,2,4-triazole-1-ethanol) or hexaconazole (α-butyl-α-(2,4-dichlorophenyl)-1H-1,2,4-triazole-1-ethanol). Most preferably, the triazole compound of formula (I) is tebuconazole.

In a preferred embodiment, the triazole compound of formula (II) is propiconazole (1-[[2-(2,4-dichlorophenyl)-4-propyl-1,3-dioxolan-2-yl]methyl]-1H-1,2,4-triazole); azaconazole (1-[[2,4-dichlorophenyl)-1,3-dioxolan-2-yl]methyl]-1H-1,2,4-triazole); or difenaconazole (1-[2-[2-chloro-4-(4-chlorophenoxy)phenyl]-4-methyl-1,3-dioxolan-2-ylmethyl]-1H-1,2,4-triazole).

In a preferred embodiment, the preservative is a triazole compound selected from the group consisting of: azaconazole, bromuconazole, cyproconazole, diclobutrazol, difenoconazole, diniconazole, diniconazole-M, epoxiconazole, etaconazole, fenbuconazole, fluquinconazole, flusilazole, flutriafol, furconazole, furconazole-cis, hexaconazole, imibenconazole, ipconazole, metconazole, myclobutanil, penconazole, propiconazole, prothioconazole, quinconazole, simeconazole, tebuconazole, tetraconazole, triadimefon, triadimenol, triticonazole, uniconazole, and uniconazole-P.

In a particularly preferred embodiment, the organic compound is tebuconazole (α-[2-(4-chlorophenyl)ethyl]-α-(1,1-dimethylethyl)-1H-1,2,4-triazole-1-ethanol) and/or propiconazole (1-[[2-(2,4-dichlorophenyl)-4-propyl-1,3-dioxolan-2-yl]methyl]-1H-1,2,4-triazole).

In a preferred embodiment, the aqueous carrier is water. Alternatively, the formulation may further comprise one or more water-miscible compounds selected from the group consisting of: glycerol, propylene glycol, ethylene glycol and the like, and mixtures thereof glycols, amine oxides, quaternary ammonium compounds, glycol ethers, esters, alcohols, phenols, diols, triols, ketones, carbamates, amides, sulfoxides, amines, acids (e.g. amino acids), modified cellulosics or the like, or combinations thereof, polymer/resins (e.g. polyvinyl alcohol), PEGS, water dispersible alkyds, polyesters, proteins, etc.

In a preferred embodiment, the formulation is applicable to engineered wood composites selected from the group consisting of: plywood, laminated veneer lumber, glue-laminated lumber (“glulam”), cross-laminated lumber, oriented strand board or I-joists.

In a preferred embodiment, the formulation comprises below about 10% w/w preservative (organic compound and metal compound, combined) content; preferably below about 5%, more preferably below about 2%; and; more preferably still below about 1% w/w preservative (organic compound and metal compound, combined) content.

In a preferred embodiment, the biocidal metal compound is present in unmodified or modified (i.e., soluble or solid particulate) form. The soluble or solid particulate form preferably comprises a chemical modification providing relatively increased stability against environmental conditions such as heat and/or chemical degradation. The soluble or solid particulate form may be a microencapsulated form and/or a micronised form. The formulation may further comprise colour/s, water repellents and/or co-solvents.

Particularly preferred form of the present invention may comprise tebuconazole and propiconazole (1:1 as the organic compound) in an approximate 3.1:1 w/w ratio with copper; tebuconazole and propiconazole (1:1 as the organic compound), in an approximate 2.6:1 to 3.0:1 w/w ratio with copper; tebuconazole and propiconazole (1:1 as the organic compound), in an approximate 3.1:1 to 4.9:1 w/w ratio with copper; and tebuconazole and propiconazole (1:1 as the organic compound), in an approximate 5.0:1 to 10:1 w/w ratio with copper. In a preferred embodiment, the copper compound is copper(II) naphthenate.

According to a second aspect of the present invention there is provided a preservative formulation for use in treating wood or other cellulosic materials, said formulation comprising:
at least one organic compound;
at least one metal compound; and
a carrier,

wherein the ratio of said at least one metal to said at least one organic compound is about 5:3 w/w.

According to a third aspect of the present invention there is provided a method of treating a substrate of wood or other cellulosic formulation which comprises applying to the substrate a preservative formulation as defined according to the first aspect of the invention.

Preferably the step of contacting said wood is performed by means selected from the group consisting of: pressure application, vacuum application, spraying, dipping, rolling, painting, or any combination thereof.

According to a fourth aspect of the present invention there is provided treated wood, when so-treated by a method defined according to the third aspect of the invention.

According to a fifth aspect of the invention there is provided a method of making a formulation for treating wood, said method comprising the step of admixing at least one organic compound and at least one metal compound in a ratio of between about 5:1 and about 1:10 w/w, with a carrier.

Preferably, the carrier is aqueous, solvent-based, oil-based, or a combination thereof.

According to a sixth aspect of the invention there is provided a formulation for treating wood, when made by a method defined according to the fifth aspect of the invention.

According to a seventh aspect of the present invention there is provided a method of treating wood, said method comprising the steps of:
contacting said wood with at least one organic compound;
contacting said wood at least one metal compound; and

wherein said at least one organic compound and said at least one metal compound are operatively associated with one or more carriers,

wherein the ratio of said at least one metal to said at least one organic compound is between about 1:1 and about 1:10 w/w.

In a preferred embodiment, the steps of contacting said wood with at least one organic compound and contacting said wood at least one metal compound are performed simultaneously such that both said organic compound and said metal compound are distributed substantially homogeneously throughout said carrier.

In a preferred embodiment, the metal compound is biocidal.

The Inventors have found that compositions according to the present invention may possess certain advantageous properties. In particular, the metal compound and the fungicidal compound containing the triazole group (hereinafter, “the triazole compound”) may exhibit synergistic fungicidal activity.

It will be understood that the metal compound may be present in a form such that metal ions are free in solution or may form part of a complex. Similarly, the triazole compound may be free in solution or may be present in the form of a salt or a complex. For example, the triazole compound could be present in the form of a complex with part of the biocidal metal ion.

The compositions according to the invention may be used to treat substrates such as wood or other cellulosic substrates (such as cotton, hessian, rope and cordage). For convenience, the invention will be described hereinafter with reference to the treatment of wood, but it will be appreciated that the other formulations may be treated analogously.

The metal compound may include copper, aluminium, manganese, iron, cobalt, nickel, zinc, gold, silver, cadmium, tin, antimony, mercury, lead and bismuth compounds. These may be either used alone or in mixtures. The preferred metals are copper and zinc used alone, in combination with each other or with one or more of the metals listed previously. The most preferred metal is copper, particularly Cu(II) ion.

The triazole compound may be any compound which contains a triazole group and which possesses biocidal activity. Preferably, the triazole compound contains the triazole group (A)

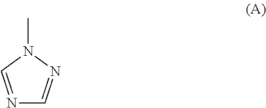

Advantageously, the triazole compound is selected from compounds of formula (I) wherein R₁ represents a branched or straight chain C₁₋₅alkyl group (e.g., t-butyl) and R₂ represents a phenyl group optionally substituted by one or more substituents selected from halogen (e.g., chlorine, fluorine or bromine) atoms and C₁₋₃alkyl (e.g., methyl), C₁₋₃alkoxy (e.g., methoxy), phenyl and nitro groups. A particularly preferred compound of formula (I) is tebuconazole: α-[2-(4-chlorophenyl)ethyl]-α-(1,1-dimethylethyl)-1H-1,2,4-triazole-1-ethanol (i.e., R₁=t-butyl; R₂=p-chlorophenyl).

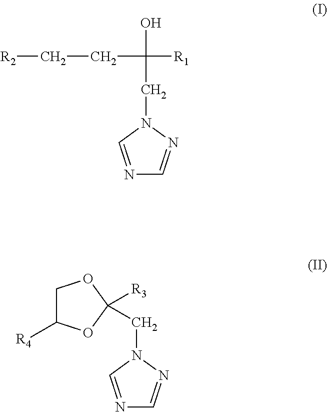

Alternatively, the triazole compound is advantageously selected from compounds of formula (II) wherein R₃ is as defined for R₂ above; and R₄ represents a hydrogen atom or a branched or straight chain C₁₋₅alkyl group (e.g., n-propyl). Particularly preferred compounds of formula (II) are propiconazole: 1-[[2-(2,4-dichlorophenyl)-4-propyl-1,3-dioxolan-2-yl]methyl]-1H-1,2,4-triazole (i.e., R₃=o,p-dichlorophenyl; R₄=n-propyl); and azaconazole: 1-[[2,4-dichlorophenyl)-1,3-dioxolan-2-yl]methyl]-1H-1,2,4-triazole (i.e., R₃=o,p-dichlorophenyl; R₄═H).

The inventive compositions may contain more than one triazole compound for example, they may contain tebuconazole and propiconazole, or a mixture of tebuconazole, propiconazole and azaconazole.

The Inventors have found that the biocidal metal may advantageously be incorporated into the composition in the form of inorganic salts of the metal ion, e.g., in the form of the metal carbonate, sulfate, chloride, hydroxide, borate, fluoride or oxide. Alternatively, the metal may be used in the form of the metal salt of a simple organic compound, e.g., in the form of a salt of a carboxylic acid such as a metal acetate. Thus, it has been found that the biocidal triazole compounds may exhibit synergistic properties when the metal ion is present in the form of such simple salts, and it is not necessary to add the metal ion in the form of a salt of, or complex with, a larger more complex organic compound which itself possesses biocidal properties. Alternatively, the metal may be in micronised form.

The optimum weight ratio of metal ion to triazole compound varies depending on the particular formulation or product to which the composition is applied and the type of organism against which protection is required. Preferably, the ratio by weight of metal to triazole compound is between about 1:1 and about 1:10, most preferably around 1:3.1 w/w. More preferably still, the metal is Cu(II) ion and the trizole compound is tebuconazole and/or propiconazole.

The concentration required for preservative treatment of wood depends on the ratio of metal to triazole compound selected, the metal chosen, the method of treatment employed, the timber species, the level of protection required and the nature and quantity of any other biocides present. The levels necessary can be determined readily by one skilled in the art. In general, the level of metal required will be in the range 25 ppm to 0.1% w/w and the level of triazole will be in the range 25 ppm to 1.0% w/w. The preferred range for waterborne treatments is to have a metal concentration of 50 ppm to 500 ppm and a triazole level of 50 ppm to 5000 ppm.

The compositions of the present invention may advantageously contain a biocidally-active quaternary ammonium compound or tertiary amine salt. These compounds aid in the formation of emulsions of triazole compounds in aqueous solutions of biocidal metal ion.

Compositions containing quaternary ammonium compounds or tertiary amine salts can form microemulsions which are particularly useful in the treatment of timber. In addition, the presence of these compounds may mean that additional organic solvents are not necessary to solubilise the triazole compound. Furthermore, the quaternary ammonium compounds and tertiary amine salts are themselves biocidal and so they enhance the overall biocidal activity of the composition. These compounds also improve penetration of the biocidal metal ion and triazole compound into the timber.

The composition in accordance with the invention comprises water as solvent/carrier. Formulations can be prepared as concentrates intended to be diluted at the treatment facility, or the formulations can be prepared in the form of dilute treatment solutions. Optionally, separate solutions of biocidal metal ion and triazole compound can be provided, e.g., in the form of two concentrates intended to be mixed before or after dilution.

Suitable formulations may be prepared, for example, by preparing aqueous solutions of metal ion complexes and subsequently adding an emulsified formulation of the triazole compound. Suitable complexing agents for the metal ion would be for example, polyphosphoric acids such as tripolyphosphoric acid, ammonia, water soluble amines and alkanolamines capable of complexing with biocidal cations; aminocarboxylic acids such as glycine, glutamic acid, ethylenediaminetetraacetic acid, hydroxyethyldiamine triacetic acid, nitrilotriacetic acid and N-dihydroxy ethylglycine; polymeric compounds which contain groups capable of complexing with metallic cations such as polyacrylic acids; hydroxycarboxylic acids such as tartaric acid, citric acid, malic acid, lactic acid, hydroxybutyric acid, glycollic acid, gluconic acid and glucoheptonic acid; phosphonic acids such as nitrilotrimethylene phosphonic acid, ethylenediaminetetra(methylenephosphonic acid), hydroxyethylidene diphosphonic acid. Where the complexing agents are acidic in nature they may be employed either as free acids or as their alkali metal or ammonium salts. These complexing agents may be used either alone or in combination with each other.

Suitable surfactants for triazole compounds include, for example, cationic, nonionic, anionic, Zwitterionic or amphoteric surfactants.

Suitable formulations can also be prepared, for example, by adding an emulsified formulation of the triazole compound to an aqueous solution of a metal salt, such as copper sulfate or zinc acetate. At certain ratios of metal ion to azole, the solubility of the azole may be sufficient to disperse the azole in the formulation using a suitable co-solvent.

Alternatively, formulations can be prepared employing only organic solvents. To prepare such formulations, a biocidal metal salt of a carboxylic acid (e.g., decanoic or octanoic acid) is prepared and dissolved in a suitable organic solvent to form a concentrate. The triazole compound can then be added directly to the concentrate or to a solution diluted with a suitable solvent such as an ester, alcohol, ester alcohol, aliphatic or aromatic hydrocarbon, glycol ether, glycol or ketone.

Concentrated formulations containing organic solvents can be diluted with water to form an emulsion which can be stabilised with surfactants if necessary.

Compositions in accordance with the invention can optionally contain other additives conventionally employed in timber preservation such as water repellents, colour additives, viscosity modifiers or corrosion inhibitors.

The compositions of the invention may contain other organic compounds including fungicides, mouldicides, termiticides, insecticides and bacteriocides. Such organic compounds include carboxylic acids such as naphthenic acids and branched aliphatic acids and their metal salts such as copper and zinc naphthenate, phenols and substituted phenols such as orthophenyl phenol and its alkali metal or ammonia salts; polyhalogenated phenols such as pentachlorophenol or tribromophenol and their alkali metal or ammonia salts; quaternary ammonium salts and tertiary amine salts such as didecyl dimethyl ammonium chloride, octyl decyl dimethyl ammonium chloride, dodecyl dimethyl benzyl ammonium chloride, dodecyl benzyl trimethyl ammonium chloride, dodecyl dimethyl amine acetate, dodecyl dimethyl amine lactate, dodecyl dimethyl amine salicylate, didodecyl methyl amine chloride; isothiazolone derivatives such as 4,5-dichloro-2-(n-octyl)-4-isothiazolin-3-one or 2-methyl-4-isothiazolin-3-one, 2n-octyl-4-isothiazolin-3-one and mixtures of those and other related compounds; sulfamide derivatives such as N,N-dimethyl-N-phenyl-(N-fluorodichloro-methylthio)-sulfonamide, N,N-dimethyl-N-tolyl-N-(dichlorofluoro-methylthio)-sulfamide; azoles such as imidazole; MBT (methylene-bis thiocyanate); IPBC (3-iodo-2-propanyl-butyl-carbamate); carbendazim and chlorothalonil; N-nitrosophenylhydroxylamine and N-nitroso cyclohexyl hydroxylamine, either as their metal salts or as metal chelates; pyrethroid type insecticides selected from the group consisting of cyano-(4-fluoro-3-phenoxyphenyl)-methyl-3-(2,2-dichloroethenyl)-2,2-dimethyl cyclopropanecarboxylate, (3-phenoxyphenyl)methyl-3-(2,2-dichloro-ethyenyl)-2,2-dimethyl-cyclopropanecarboxylate, cyano-(3-phenoxy-phenyl)-methyl-2-(4-chlorophenyl)-3-methylbutyrate, and mixtures thereof; organo-phosphorous, carbamate and organochlorine insecticides such as lindane.

Other biocidally-active elements may also be present such as boron, in any form, for example boric acid, boron or boron esters and also fluorides and silicafluorides.

Particularly preferred compositions in accordance with the invention comprise copper(II) ion, one or more triazole compounds which may be tebuconazole and/or propiconazole, and optionally an alkanolamine, as well as optionally borate ion and/or a quaternary ammonium compound or a mixture of quaternary ammonium compounds.

According to a further form of the present invention there is provided a method of treating timber or another cellulosic substrate of the type hereinbefore described, which comprises applying to the substrate a composition as defined above.

The skilled person will be well acquainted with the various methods of treating the substrates with aqueous solutions. For example, the compositions according to the invention may be applied to wood by dipping, spraying, deluging, brushing, vacuum impregnation, pressure impregnation and/or any other applicable method. Other types of substrate may be treated analogously.

### BRIEF DESCRIPTION OF THE FIGURES

A preferred embodiment of the invention will now be described with reference to the accompanying Figures, in which:

FIG. 1 is a plot of minimum effective retentions (MER) of copper naphthenate, “Az”=an approximate 1:1 w/w mixture of tebuconazole and propiconazole, and the 1:3 w/w combination of total Cu/Az (see, Example 4). This plot demonstrates a synergy for the formulation tested such that the preservative effect is beyond that expected for the individual (i.e., additive) preservatives.

FIG. 2 is a plot of the results obtained from a trial involving various timber preservatives against Fomitopsis lilacinogilva (see, Example 6, below). In FIG. 2, A: Untreated control; B: ZnN, 0.1% m/m; C: ZnN, 0.2% m/m; D: ZnN, 0.3% m/m; E: Az, 0.06% m/m; F: Az/ZnN (1:1), 0.06/0.06% m/m; and G: Az/ZnN (1:2), 0.06/0.12% m/m); “Az”=an approximate 1:1 w/w mixture of tebuconazole and propiconazole.

FIG. 3 is a plot of the results obtained from a trial involving various timber preservatives against Coniophora olivacea (see, Example 6, below). In FIG. 3, A: Untreated control; B: ZnN, 0.1% m/m; C: ZnN, 0.2% m/m; D: ZnN, 0.3% m/m; E: Az, 0.06% m/m; F: Az/ZnN (1:1), 0.06/0.06% m/m; and G: Az/ZnN (1:2), 0.06/0.12% m/m); “Az”=an approximate 1:1 w/w mixture of tebuconazole and propiconazole.

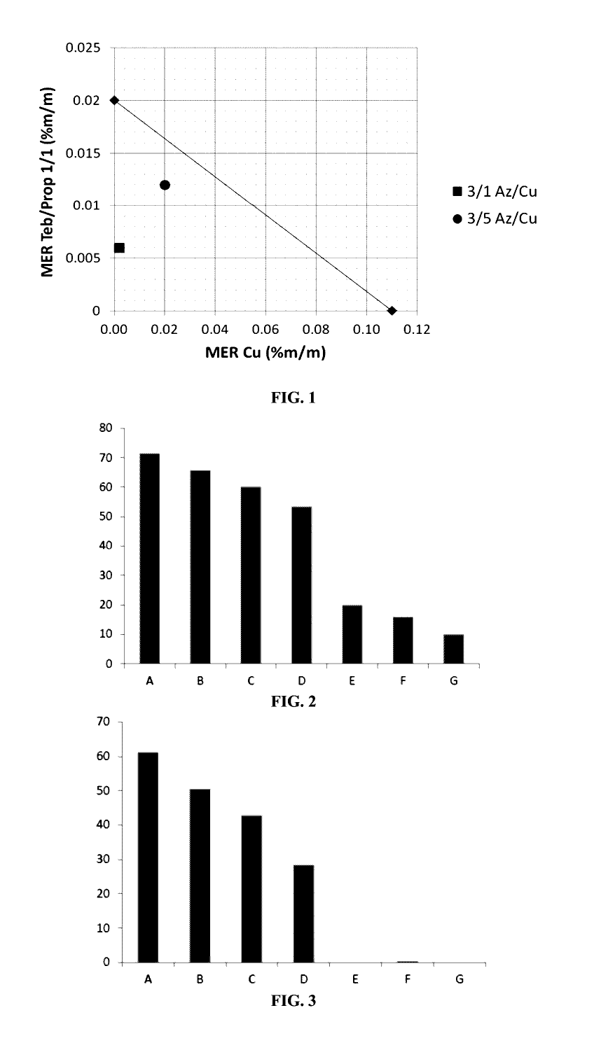

### EXAMPLE 1

A ready to use solution; metal to azole ratio 1:4, prepared combining the various raw materials in an appropriate solvent or mixture of solvents.

| Component | % w/v |
|---|---|
| Tebuconazole | 0.45 |
| Propiconazole | 0.45 |
| Permethrin | 0.32 |
| Copper (as copper naphthenate) | 0.225 |
| Co-solvent | 0.75 |
| Wax | 1.00 |
| Resin | 1.00 |
| White spirit | Balance |

### EXAMPLE 2

A ready to use solution; metal to azole ratio 1:3

| Component | % w/v |
|---|---|
| Tebuconazole | 0.45 |
| Propiconazole | 0.45 |
| Permethrin | 0.32 |
| Copper (as copper naphthenate) | 0.30 |
| Co-solvent | 0.75 |
| Wax | 1.00 |
| Resin | 1.00 |
| White spirit | Balance |

### EXAMPLE 3

A ready to use solution; metal to azole ratio 1:2.6

| Component | % w/v |
|---|---|
| Tebuconazole | 0.45 |
| Propiconazole | 0.45 |
| Permethrin | 0.32 |
| Copper (as copper naphthenate) | 0.35 |
| Co-solvent | 0.75 |
| Wax | 1.00 |
| Resin | 1.00 |
| White spirit | Balance |

It will be appreciated that the illustrated ready-to-use solvent-based formulations used in the treatment of wood achieves the required penetration of the wood with actives that are stable in these formulations. It will be further appreciated that the inventive formulation substantially overcomes or ameliorates many of the disadvantages inherent in the art.

### EXAMPLE 4

The synergy between the azoles tebuconazole/propiconazole and copper, is demonstrated by way of the results of field trials in Hawaii, where the decay hazard is known to be very severe. Radiata pine sapwood panels (200×70×25 mm) were treated with various preservatives and exposed on racks at 45°, using a method generally described as the “flat panel test” (Reference: Australasian Wood Preservation Committee, Protocols for Assessment of Wood Preservatives, March 2007 Revision, pp.32). Untreated controls, solvent-treated controls and panels treated with reference preservatives (e.g., CCA) were also included in this field test. The treatments of interest are summarised in Table 2, below.

TABLE 2
Results of Hawaiian Field Trials

| | Retention | Cu/Azole | |
|---|---|---|---|
| Active(s) | (% m/m) | ratio | Comment |
| Copper naphthenate | 0.11 | n/a | Heavily decayed |
| (CuN) | | | |
| Tebuconazole/ | 0.04, 0.02 (total | n/a | Lowest retention |
| propiconazole (1:1) | azole) | | rated 7 |
| Tebuconazole/ | 0.03/0.01 (total | 1:3 | Lowest retention |
| propiconazole (1:1), | azole/Cu) | | rated 7 |
| CuN | 0.006/0.002 | | |

Note: All formulations contained the insecticide permethrin at a concentration sufficient to deliver approximately 0.02% m/m active in the treated panels. After approximately three years outdoor exposure in Hawaii, the specimens were rated using a typical 0 to 10 rating system (e.g., Evaluation Standard E25, AWPA Book of Standards, 2010, American Wood Protection Association, Birmingham, Ala.), where 7 is the lowest score where the specimen is deemed still to be serviceable. A score of 7 indicates that 10-30% of the cross-section has been decayed.

Several observations became apparent upon inspection of the specimens after three years exposure. Firstly copper naphthenate (CuN) alone performs very poorly at this field test site. Copper naphthenate treated specimens were heavily decayed, even at a copper retention of 0.11% m/m Cu. The minimum effective retention of CuN to prevent decay was, at the three year inspection, >0.11% m/m. The minimum effective retention of azoles tebuconazole and propiconazole, to prevent decay was 0.02% m/m (total azole). If the anti-fungal effectiveness of the combination of azole and copper was additive, then it would be expected that the minimum effective retention would fall approximately on the diagonal line shown graphically in FIG. 3, that connects the minimum effective retention of tebuconazole/propiconazole (1:1) on the vertical axis and the minimum effective retention of copper (as CuN) on the horizontal axis.

However the combination of copper naphthenate and tebuconazole/propiconazole at a 1:3 ratio (total copper metal to azole) gave surprisingly superior results, even at low retentions. The minimum effective retention of the copper naphthenate and tebuconazole/propiconazole at a 1:3 ratio (total copper metal to azole) was approximately 0.006% m/m total azole (and 0.002% m/m copper). The synergy between this combination of actives is readily apparent. Synergy is also apparent for the approximate 5:3 w/w combination of actives.

### EXAMPLE 5

“Hi Azole, Lo Copper”—In a laboratory bioassay, the benefit of combining relatively low levels of metal ions with azoles was demonstrated. The bioassay was carried out in accordance with recognised methods (see, Protocols for the Assessment of Wood Preservatives, Australasian Wood Preservation Committee, March 2007 Revision, Ensis, Clayton).

Radiata pine sapwood (20×20×10 mm) specimens were treated with various preservative formulations. After drying the specimens were saturated with water and leached in a shaking water-bath at 35° C. for seven days, with daily changes of water. After leaching, the specimens were vacuum oven dried, before being sterilised in readiness for the fungal bioassay. The bioassay was carried out in accordance with standard laboratory techniques, by an independent research provider.

Mass loss was used to determine the effectiveness of a preservative treatment. In general, the more effective the preservative treatment the lower the mass loss. Decay is deemed to have been prevented if the mass loss is less than 3%.

Some basidiomycete decay fungi are more tolerant to azoles that others. In this bioassay, a selection of brown rot fungi were chosen. One of those chosen, Coniophora olivacea, is relatively resistant to azoles. The 1:1 combination of tebuconazole and propiconazole at a retention of 0.03% m/m (total azole) was found to be decayed by C. olivacea, with a mean mass loss of 8.6% recorded.

However, the incorporation of copper, in the form of copper naphthenate, at an amount to give a total azole to copper ratio of 4:1, reduced the mass loss to 4.9%. The total azole retention was 0.03% m/m. Although decay was not prevented entirely, it was reduced significantly.

A 5:1 azole to copper ratio (total azole retention=0.03% m/m) also produced a lower mean mass loss than for azoles alone. The untreated controls were heavily decayed, with a mass loss of 61%.

### EXAMPLE 6

In a laboratory bioassay, the benefit of combining relatively low levels of metal ions with azoles was demonstrated. The bioassay was carried out in accordance with recognised methods (see, Protocols for the Assessment of Wood Preservatives, Australasian Wood Preservation Committee, March 2007 Revision, Ensis, Clayton).

Radiata pine sapwood (20×20×10 mm) specimens were treated with various preservative formulations. After drying the specimens were saturated with water and leached in a shaking water-bath at 35° C. for seven days, with daily changes of water. After leaching, the specimens were vacuum oven dried, before being sterilised in readiness for the fungal bioassay. The bioassay was carried out in accordance with standard laboratory techniques, by an independent research provider.

Mass loss was used to determine the effectiveness of a preservative treatment. In general, the more effective the preservative treatment the lower the mass loss. Decay is deemed to have been prevented if the mass loss is less than 3%.

Some basidiomycete decay fungi are more tolerant to azoles that others. In this bioassay, a selection of brown rot fungi were chosen. One of those chosen, Coniophora olivacea, is relatively resistant to azoles. The 1:1 combination of tebuconazole and propiconazole at a retention of 0.06% m/m (total azole) was found to be decayed by C. olivacea, with a mean mass loss of 0% recorded.

However, the incorporation of zinc, in the form of zinc naphthenate, at an amount to give a total azole to zinc ratio of 1:2, also provided 0% mass loss. The total azole retention was 0.06% m/m. A 1:1 azole to zinc ratio (total azole retention 0.06% m/m) also produced a lower mean mass loss than for azoles alone (0.4%) The untreated controls were heavily decayed, with a mass loss of 61.2%.

Fomitopsis lilacinogilva is a wood-rotting bracket fungus common in many places of Gondwanaland origin. It is found on logs, stumps, and some outdoor wooden constructions. It forms fans, shelves, pads or crusts, to 100 mm across, is hairy, crusted above, zoned pinkish and brownish.

The results against Fomitopsis lilacinogilva were less spectacular. Azole/zinc 1:2 gave 10% mass loss; 1:1 gave 15.9% mass loss; and azoles alone gave 19.9% mass loss versus the control (71.5% mass loss).

As used in this example, the expression “azoles” refers to a 1:1 mixture of tebuconazole and pripioconazole.

TABLE 3
Metal-Azole formulations against F. lilacinogilva and C. olivacea

| | | F. lilacino-gilva | C. olivacea |
|---|---|---|---|
| No. | Actives/Retentions | Mass Loss (%) | Mass Loss (%) |
| A | Untreated control | 71.5 | 61.2 |
| B | ZnN, 0.1% m/m | 65.8 | 50.5 |
| C | ZnN, 0.2% m/m | 60.2 | 42.8 |
| D | ZnN, 0.3% m/m | 53.5 | 28.4 |
| E | Az, 0.06% m/m | 19.9 | 0 |
| F | Az/ZnN (1:1), | 15.9 | 0.4 |
| | 0.06/0.06% m/m | | |
| G | Az/ZnN (1:2), | 10 | 0 |
| | 0.06/0.12% m/m | | |

“Az” = tebuconazole/propiconazole (1:1)

The above results hint at a potential synergy between the azoles tebuconazole/propiconazole and zinc. As can be seen from the above data, zinc naphthenate, used alone, has a weak preservative effect (i.e., at 0.3% m/m, 53.5% against F. lilacinogilva and 28.4% against C. olivacea). However, when just 20% of this retention (i.e., 0.06% m/m) is used in a 1:2 ratio with a combination with azoles (i.e., a 1:1 mixture of tebuconazole and propiconazole at 0.12% m/m total azoles), the decay falls to 10% for F. lilacinogilva; this appears to be more than merely additive—and suggests that some degree of insecticide synergy may be operative.

### EXAMPLE 7

A ready to use water-based solution; metal to azoles ratio 1:10, prepared combining the various raw materials in an appropriate solvent or mixture of solvents.

| Component | % w/v |
|---|---|
| Tebuconazole | 0.45 |
| Propiconazole | 0.45 |
| Permethrin | 0.32 |
| Copper (as copper octanoate) | 0.09 |
| Co-solvent | 0.75 |
| Wax | 1.00 |
| Resin | 1.00 |
| Water | Balance |

### EXAMPLE 8

A ready to use water-based solution; metal to azoles ratio 1:1, prepared combining the various raw materials in an appropriate solvent or mixture of solvents.

| Component | % w/v |
|---|---|
| Tebuconazole | 0.45 |
| Propiconazole | 0.45 |
| Permethrin | 0.32 |
| Copper (as copper octanoate) | 0.90 |
| Co-solvent | 0.75 |
| Wax | 1.00 |
| Resin | 1.00 |
| Water | Balance |

Although the invention has been described with reference to specific examples it will be appreciated by those skilled in the art that the invention may be embodied in many other forms.

Reference throughout the specification and claims to ranges, e.g., “the ratio of said at least one metal to said at least one organic compound is between about 5:1 and about 1:10 w/w” should be construed as encompassing the quoted limits (plus a reasonable tolerance appropriate to the art)—and all ratios in between.

Reference throughout this specification to “one embodiment” or “an embodiment” means that a particular feature, structure or characteristic described in connection with the embodiment is included in at least one embodiment of the present invention. Thus, the phrases “in one embodiment” or “in an embodiment” throughout this specification are not necessarily all referring to the same embodiment, but may. Furthermore, the particular features, structures or characteristics may be combined in any suitable manner, as would be apparent to one of ordinary skill in the art from this disclosure.

In the description provided herein, numerous specific details are set forth. However, it is understood that embodiments of the invention may be practiced without these specific details. Thus, while there has been described what are believed to be the preferred embodiments of the invention, those skilled in the art will recognise that other and further modifications may be made thereto without departing from the spirit of the invention, and it is intended to claim all such changes and modifications as fall within the scope of the invention. For example, any formulas given above are merely representative of procedures that may be used.

1. A method of treating a substrate of wood or other cellulosic material, comprising:
treating the substrate against an azole-tolerant fungus by applying to the substrate a preservative formulation comprising:
at least one azole fungicide,
at least one metal compound having a biocidal effect, and
an aqueous carrier,
wherein the at least one metal compound to the at least one azole fungicide is between about 5:1 and about 1:10 w/w to provide a synergistic fungicidal effect to said preservative formulation in protecting from decay said wood or other cellulosic materials treated with said preservative formulation.

2. The method of claim 1, wherein the azole-tolerant fungus is a brown rot.

3. The method of claim 2, wherein the azole-tolerant fungus is Coniophora olivacea.

4. The method of claim 1, wherein applying the preservative formulation to the substrate is performed by pressure and vacuum application, spraying, dipping, rolling, painting, or any combination thereof

5. The method of claim 1, wherein the substrate is Radiata pine.

6. The method of claim 1, wherein the ratio of the at least one metal compound to the at least one azole fungicide is between about 1:3 and about 1:5 w/w.

7. The method of claim 1, wherein the at least one metal compound is a compound of a metal selected from the group consisting of: copper, aluminium, manganese, iron, cobalt, nickel, zinc, silver, cadmium, tin, antimony, mercury, lead and bismuth.

8. The method of claim 1, wherein the at least one metal compound is a compound of copper or zinc.

9. The method of claim 1, wherein the at least one metal compound is a copper or zinc compound selected from the group consisting of: naphthenate, octanoate (2-ethylhexanoate), abietate, rosin, tallate, oxine or a copper or zinc soap.

10. The method of claim 1, wherein said at least one azole fungicide is a triazole compound of formulae (I) or (II): 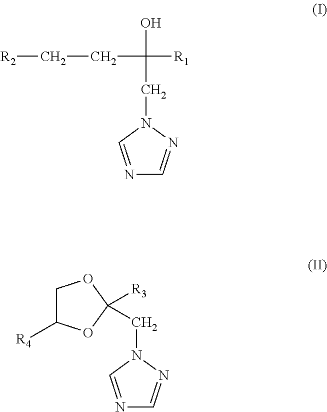
wherein R₁ represents a branched or straight chain C₁₋₅alkyl group;
R₂ represents a phenyl group optionally substituted by one or more substituents selected from halogen, C₁₋₃alkyl, C₁₋₃alkoxy, phenyl and nitro;
R₃ is as defined for R₂; and
R₄ represents a hydrogen atom or a branched or straight chain C₁₋₅alkyl.

11. The method of claim 12, wherein said triazole compound of formula (I) is tebuconazole (α-[2-(4-chlorophenyl)ethyl]-α-(1,1-dimethylethyl)-1H-1,2,4-triazole-1-ethanol) or hexaconazole (α-butyl-α-(2,4-dichlorophenyl)-1H-1,2,4-triazole-1-ethanol).

12. The method of claim 12, wherein said triazole compound of formula (II) is propiconazole (1-[[2-(2,4-dichlorophenyl)-4-propyl-1,3-dioxolan-2-yl]methyl]-1H-1,2,4-triazole); azaconazole (1-[[2,4-dichloro-phenyl)-1,3-dioxolan-2-yl]methyl]-1H-1,2,4-triazole); or difenaconazole (1-[[2-chloro-4-(4-chlorophenoxy)phenyl]-4-methyl-1,3-dioxolan-2-ylmethyl]-1H-1,2,4-triazole).

13. The method of claim 1, wherein the at least one azole fungicide comprises tebuconazole.

14. The method of claim 1, wherein the at least one azole fungicide is a triazole compound selected from the group consisting of: azaconazole, bromuconazole, cyproconazole, diclobutrazol, difenoconazole, diniconazole, diniconazole-M, epoxiconazole, etaconazole, fenbuconazole, fluquinconazole, flusilazole, flutriafol, furconazole, furconazolecis, hexaconazole, imibenconazole, ipconazole, metconazole, myclobutanil, penconazole, propiconazole, prothioconazole, quinconazole, simeconazole, tebuconazole, tetraconazole, triadimefon, triadimenol, triticonazole, uniconazole, and uniconazole-P.

15. A method of enhancing the efficacy of a wood preservative formulation containing at least one azole fungicide against azole-tolerant fungi, comprising adding at least one metal compound having a biocidal effect such that the ratio of the at least one metal compound to the at least one azole fungicide is between about 5:1 and about 1:10 w/w to provide a synergistic fungicidal effect to said preservative formulation in protecting from decay said wood or other cellulosic materials treated with said preservative formulation.

16. The method of claim 15, wherein the at least one azole fungicide is a triazole compound selected from the group consisting of: azaconazole, bromuconazole, cyproconazole, diclobutrazol, difenoconazole, diniconazole, diniconazole-M, epoxiconazole, etaconazole, fenbuconazole, fluquinconazole, flusilazole, flutriafol, furconazole, furconazole-cis, hexaconazole, imibenconazole, ipconazole, metconazole, myclobutanil, penconazole, propiconazole, prothioconazole, quinconazole, simeconazole, tebuconazole, tetraconazole, triadimefon, triadimenol, triticonazole, uniconazole, and uniconazole-P.

17. The method of claim 15, wherein the at least one metal compound is a copper or zinc compound selected from the group consisting of: naphthenate, octanoate (2-ethylhexanoate), abietate, rosin, tallate, oxine or a copper or zinc soap.

18. The method of claim 15, wherein the at least one metal compound is a copper (II) compound.

19. The method of claim 15, wherein the azole-tolerant fungus is Coniophora olivacea.

20. The method of claim 15, wherein the ratio of the at least one metal compound to the at least one azole fungicide is between about 1:3 and about 1:5 w/w.
